(19) United States
(12) Patent Application Publication
(10) Pub. No.: US 2025/0180259 A1
(43) Pub. Date: Jun. 5, 2025

(54) Buffer Storage for a Cooling Circuit of a Thermostatic Assembly and Thermostatic Assembly with a Buffer Storage

(71) Applicant: Binder GmbH, Tuttlingen (DE)

(72) Inventors: Christian HOEFER, Muehlhausen-Ehingen (DE); Hartmut WINKLER, Tuttlingen (DE); Philipp ZIMMERER, Rottweil (DE)

(73) Assignee: Binder GmbH, Tuttlingen (DE)

(21) Appl. No.: 18/963,944

(22) Filed: Nov. 29, 2024

(30) Foreign Application Priority Data
Dec. 1, 2023 (DE) 10 2023 133 726.2

(51) Int. Cl. F25B 41/40; B01L 1/02

(52) U.S. Cl. CPC F25B 41/40; B01L 1/025; F25B 2400/24

(57) ABSTRACT

A buffer storage for a cooling circuit of a thermostatic assembly includes a tank having a tank wall enclosing an interior volume and a heat exchanger including a first side with a first intake and a first discharge for a first coolant and a second side with a second intake and a second discharge for a second coolant. A first tubeline is guided through the tank wall to the first intake and a second tubeline is guided from the first discharge through the tank wall to an exterior volume. A third tubeline is guided through the tank wall to the second intake. The second discharge is connected across a T fitting with a fourth tubeline terminating in the interior volume. A fifth tubeline is guided through the tank wall and a sixth tubeline is guided from the interior volume through the tank wall to a thermostatic assembly outside the tank.

### CROSS REFERENCE TO RELATED APPLICATIONS

This application claims priority to German Patent Application No. DE 10 2023 133 726.2, filed Dec. 1, 2023, which is incorporated by reference in its entirety.

### FIELD OF APPLICATION

The application relates to a buffer storage for a cooling circuit of a thermostatic assembly and a thermostatic assembly with a buffer storage, in particular for laboratory chambers, climate chambers, cold chambers or environment simulation chambers.

### BACKGROUND

The use of a thermostatic assembly for the temperature control of a sample compartment of laboratory chambers, climate chambers, cold chambers or environment simulation chambers in order to regulate or fine tune the temperature in the sample compartment in the desired manner is known.

DE 10 2004 040 737 A1 discloses an assembly for the control or regulation means of a constant forerun or feedline temperature at liquid cooling and in heat pumps, wherein a buffer circuit, comprising a buffer liquid for the energy transport, is provided which is connected with a heating/cooling circuit and a consumer each, wherein into the storage circuit a storage reservoir is integrated, and wherein in the storage circuit into the connection to the cooling/heating circuit a buffer storage, through which a storage liquid can flow in one direction, and the consumers are connected in series and parallel to the buffer storage, a connection is provided, whose throughflow is controllable or adjustable, between an inlet line and an outlet line of the buffer storage.

Such assembly enables maintaining and regulating the forerun at a constant temperature; if desired, regulating the heating and cooling capacity can be limited at the consumer. The buffer storage acts herein as energy storage and energy is removed and stored as required. As a rule, known buffer storages are implemented as tanks with an inlet and an outlet.

### SUMMARY

The problem addressed by the application comprises providing a buffer storage with which a more effective buffer storage is enabled. The problem is resolved through a buffer storage as disclosed herein.

Advantageous implementations and further developments of the application are disclosed herein in some embodiments.

The buffer storage according to the application for a cooling circuit of a thermostatic assembly comprises a tank comprising a tank wall encompassing an inner volume and a heat exchanger disposed in the interior volume of the tank with a first side with a first intake and a first discharge for a first coolant and a second side separated from the first side by a diathermic wall with a second intake and a second discharge for a second coolant, wherein a first tubeline is guided from the exterior volume outside the tank through the tank wall to the first intake and a second tubeline is guided from the first discharge through the tank wall to the exterior volume outside of the tank, wherein a third tubeline is guided from the exterior volume outside of the tank through the tank wall to the second intake, wherein the second discharge is connected across a T fitting with a fourth tubeline terminating into the interior volume of the tank as well as also with a fifth tubeline guided through the tank wall to the exterior volume outside of the tank and wherein a sixth tubeline is guided from the interior volume of the tank through the tank wall to the exterior volume outside of the tank.

Stated differently, the application is based on the concept of disposing the heat exchanger within the tank of the buffer storage. In such a disposition the buffer storage can not only be utilized for storing the cold coolant but also be adjusted in particular also when no throughflow through the buffer storage takes place.

The T fitting is preferably implemented as a three-way valve. This implementation enables specifically selecting whether coolant from the second side of the heat exchanger is to be transported first into the buffer storage or directly into a cooking circuit connected with the buffer storage.

According to an advantageous physical form of the application the sixth tubeline comprises an intake end disposed in the interior volume of the tank, which intake end is disposed in a top region of the tank. Extraction of coolant can thereby be carried out in the top region of the tank.

An advantageous embodiment of the application provides for the fourth tubeline to comprise a discharge end disposed preferably substantially centrally in the interior volume in a bottom region of the tank. The supply of coolant from the second side of the heat exchanger is thereby enabled to take place in the bottom region of the tank. When the coolant heats in the interior volume of the tank, due to the convective flow of heat thorough blending of the coolant can take place. The central supply can ensure a uniform distribution of the coolant.

According to an especially preferred embodiment of the application a perforated sheet can be disposed in the interior volume of the tank, in particular in the bottom region of the tank. Such a perforated sheet can ensure a more uniform temperature distribution of the coolant in the tank.

The discharge end of the fourth tubeline is preferably disposed between the perforated sheet and the bottom wall of the tank. It is thereby enabled that newly supplied coolant enters in the bottom region underneath the perforated sheet where homogenization of the temperature distribution can take place.

The fifth tubeline and the sixth tubeline advantageously terminate with a discharge end in a second T fitting, in particular in a three-way valve which is especially preferably developed as a three-way switchover valve. This second T fitting which in particular is developed as a three-way valve or a three-way switchover valve enables specifically selecting whether coolant is to be extracted from the buffer storage or directly from the second side of the heat exchanger.

According to a preferred embodiment of the application the heat exchanger is developed as a plate heat exchanger or as a coaxial tube heat exchanger. Such heat exchangers can be constructed compactly and enable good heat transfer.

A thermostatic assembly according to the application comprises a cooling circuit with a coolant, wherein the cooling circuit comprises a cold source, a consumer heat exchanger in the return of the cold source and a circulation pump, wherein between the return of the cold source and the forerun of the consumer heat exchanger a first three-way junction and between the return of the consumer heat exchanger and the forerun of the cold source a second three-way junction is disposed, wherein the first three-way junction and the second three-way junction are connected to a bypass line and the circulation pump is disposed either between the first three-way junction and the forerun of the consumer heat exchanger or between the return of the consumer heat exchanger and the second three-way junction, wherein the thermostatic assembly comprises a buffer storage according to some embodiments as disclosed herein, wherein the second side of the heat exchanger disposed in the buffer storage forms the cold source, and the first side of the heat exchanger disposed in the buffer storage is part of an external cold circuit.

A three-way junction is to be understood as a convergence of at least three inflows and/or outflows. A three-way junction can, for example, be realized by a T fitting.

By means of the bypass line, a subcircuit can be formed from the first three-way junction, via the consumer heat exchanger to the second three-way junction, and via the bypass line back to the first three-way junction. This enables the subcircuit to compensate for the energy difference supplied at the consumer heat exchanger or extracted from it across the first three-way junction, and by doing so, circulating a smaller quantity of coolant, essentially the coolant in the subcircuit, and maintaining the quantity of coolant at the desired temperature.

The external refrigerant circuit can comprise a refrigeration unit and be operated with a coolant that enables temperatures markedly below the freezing point of water. Such separation of cooling circuit and external refrigerant circuit across the heat exchanger can enable disposing the external refrigerant circuit at installation into a laboratory chamber, climate chamber, cold chamber or environment simulation chamber such that the external refrigerant circuit is disposed in a machine compartment separated from the sample compartment.

According to an advantageous further development of the application an intake opening of the third tubeline is connected with a discharge of the second three-way junction and the discharge opening of the fifth tubeline and of the sixth tubeline terminate into a T fitting whose outlet is connected with an inlet of the first three-way junction. Thereby a compact arrangement is enabled.

The external refrigerant circuit preferably comprises a refrigeration unit, and the buffer storage is disposed such that the first tubeline is in connection with the return of the refrigeration unit and the second tubeline is in connection with the forerun of the refrigeration unit. Thereby a compact arrangement is enabled.

The first three-way junction and/or the second three-way junction is or are preferably developed as a three-way valve. The inflow and the outflow through the three-way junction can thereby be appropriately regulated.

It should be noted that by three-way valve within the meaning of the present application any valve is to be understood that comprises at least three paths. For example, the application can also be realized by a correspondingly connected four-way valve.

According to an especially preferred embodiment of the application the first three-way junction is developed as a three-way valve, wherein the circulation pump is disposed between the return of the consumer heat exchanger and the second three-way junction, wherein the first inlet of the three-way valve is in connection with the return of the cold source, one outlet of the three-way valve with the forerun of the consumer heat exchanger and a second inlet of the three-way junction is in connection across the second three-way junction with the return of the circulation pump and the forerun of the cold source.

Such an assembly can, for example, be operated in the following manner: The cold source makes available a cold coolant which, with the aid of the circulation pump, is supplied through the first inlet of the three-way valve and the outlet of the three-way valve to the consumer heat exchanger. Across the consumer heat exchanger a sample compartment can be cooled wherein to the coolant energy is supplied in the consumer heat exchanger. As a rule, the cooling circuit is laid out of such size that the temperature of the coolant through the consumer does not change too significantly. In the return of the circulation pump a temperature sensor can be disposed with the aid of which the supplied energy difference can be determined. At the first inlet of the three-way valve subsequently such quantity of cold coolant can be supplied that at the outlet of the three-way valve the coolant is provided at the desired temperature. Only a quantity of warmer coolant flowing back from the consumer heat exchanger that corresponds to the quantity of supplied cold coolant is carried by the circulation pump directly to the cold source in order to be able to be cooled here anew.

An especially advantageous further development of the application provides for a heating unit to be disposed between the first three-way junction and the consumer heat exchanger. Such a heating unit enables the temperature control over a wider temperature range, in particular the temperature control at temperatures that lie above the temperature of the coolant provided by the cold source.

A laboratory chamber, climate chamber, cold chamber or environment simulation chamber with a sample compartment comprises a thermostatic assembly as described above, wherein the consumer heat exchanger is disposed such that it maintains temperature control or regulation in the sample compartment. The advantages of such a laboratory chamber, climate chamber, cold chamber or environment simulation chamber correspond to the advantages described by means of the thermostatic assembly.

A preferred laboratory chamber, climate chamber, cold chamber or environment simulation chamber with a sample compartment comprises an above described thermostatic assembly in which the cold source is part of a second heat exchanger across which an external refrigerant circuit is coupled to the cooling circuit, wherein the consumer heat exchanger is disposed such that it controls the temperature of the sample compartment and wherein the external refrigerant circuit, preferably including the second heat exchanger, is disposed in a machine compartment separated from the sample compartment, which in particular comprises ventilation apertures. In such a separation between external refrigerant circuit and cooling circuit, utilizing a combustible cooling means in the external refrigerant circuit since the external refrigerant circuit is disposed in a machine compartment, separated from the sample compartment, which can be well ventilated such that here the safety requirements demanded of refrigerant circuits with combustible refrigeration agents can be met which is not possible in a closed sample compartment. The energy supply into the sample compartment can take place by means of the cooling circuit wherein the second heat exchanger is disposed outside of the sample compartment in the machine compartment.

It is especially preferred for the external refrigerant circuit to comprise a hydrocarbon, in particular propane or isobutane, as the refrigeration agent. Such refrigeration agents represent a climate friendly alternative to halogenated refrigeration agents since they do not contribute to the greenhouse effect, wherein, however, heightened safety requirements for the use of such refrigeration agents must be observed due to their combustibility. These heightened safety requirements can be met by using a thermostatic assembly that includes a separation between external refrigerant circuit and cooling circuit wherein the external refrigerant circuit is disposed in a machine compartment separated from the sample compartment and the energy input into the sample compartment is carried out across the cooling circuit.

In the following the application will be explained in detail in conjunction with an embodiment example. Therein depict:

### BRIEF DESCRIPTION OF THE DRAWINGS

FIG. 1 a schematic representation of an embodiment example of a buffer storage according to the application with a heat exchanger disposed therein,

FIG. 2 a partially sectioned perspective view of the buffer storage according to some embodiments as disclosed herein,

FIG. 3 a schematic representation of a thermostatic assembly with a cold source, a consumer heat exchanger, a circulation pump, a buffer storage according to FIG. 1 with a heat exchanger disposed therein and an external refrigerant circuit with refrigeration unit, and,

FIG. 4 a schematic representation of a laboratory chamber, climate chamber, cold chamber or environment simulation chamber with a thermostatic assembly according to FIG. 3.

### DETAILED DESCRIPTION

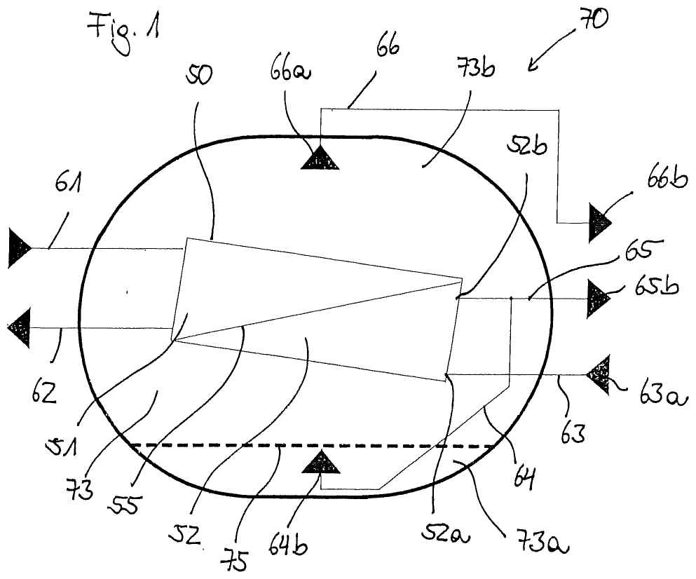

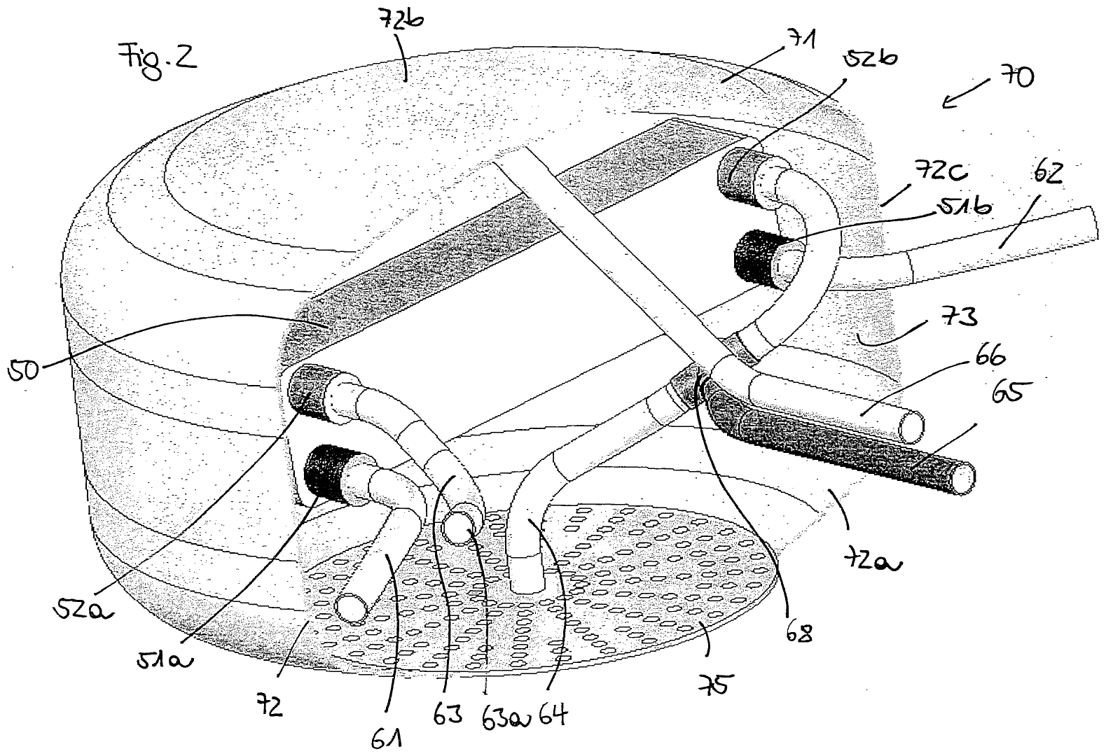

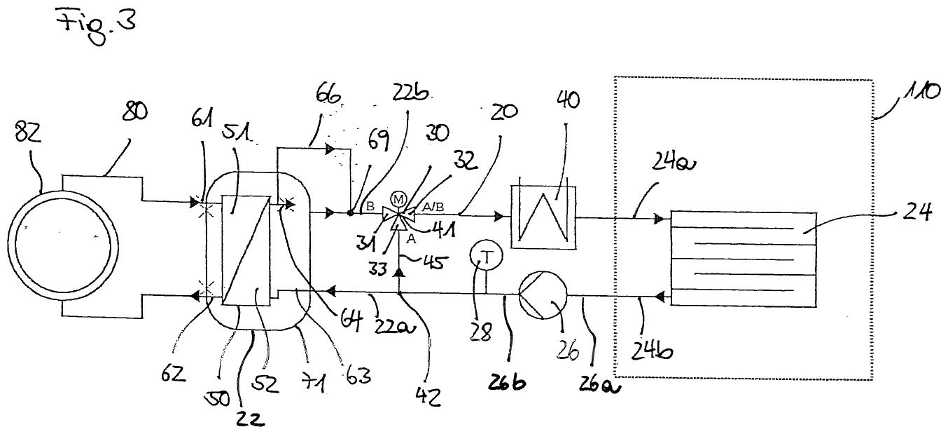

FIGS. 1 and 2 show two views of an embodiment example of a buffer storage 70, FIG. 3 shows an embodiment example of a thermostatic assembly 10 with a cooling circuit 20 with a buffer storage 70 according to FIGS. 1 and 2, and FIG. 4 illustrates the installation of such a thermostatic assembly 10. Same reference numbers denote same or functionally same components wherein, for clarity of view, not all reference numbers are provided in all Figures.

The buffer storage 70 comprises a tank 71 having a tank wall 72 encompassing an interior volume 73. The tank wall 72 can comprise a bottom wall 72a, a top wall 72b, and a side wall 72c. The interior volume 73 can comprise a bottom region 73a, in particular bordering the bottom wall 72a, and a top region 73b, in particular bordering the top wall 72b.

In the interior volume 73 of the tank 71 a heat exchanger 50 is preferably disposed between the bottom region 73a and the top region 73b. The heat exchanger 50 comprises a first side 51 with a first intake 51a and a first discharge 51b for a first coolant as well as second side 52, separated from the first side 51 by a diathermic wall 55, with a second intake 52a and a second discharge 52b for a second coolant. The heat exchanger 50 can be developed as a plate heat exchanger or a coaxial tube heat exchanger.

A first tubeline 61 is guided from the exterior volume outside of the tank 71 through the tank wall 72 to the first intake 51a of the first side 51 and a second tubeline 62 is guided from the first discharge 51b of the first side 51 through the tank wall 72 toward the exterior volume outside of the tank 71.

A third tubeline 63 is guided from outside of the tank 71 through the tank wall 72 to the second intake 52a of the second side 52, wherein the second discharge 52b of the second side 52 is connected across a T fitting 68 with a fourth tubeline 64, terminating into the interior volume 73 of tank 71, as well as also with a fifth tubeline 65 guided through the tank wall 72 toward the exterior volume outside of tank 71. The second coolant can thereby be optionally conducted into the interior volume 73 of tank 71 as well as also directed outwardly, for example into the cooling circuit 20 of the thermostatic assembly 10 (cf. FIG. 3). The T fitting 68 can be implemented for example as a three-way valve in order to direct the flow of the second coolant appropriately.

The fourth tubeline 64 can comprise a discharge end 64b, disposed in the interior volume 73 of tank 71, which is disposed in the interior volume 73, preferably substantially centrally, in the bottom region 73a of tank 71.

In the interior volume 73 of tank 71 can be disposed a perforated sheet 75 which is disposed in particular in the bottom region 73a of the tank 71. The perforated sheet 75 comprises herein in particular regularly distributed perforations, for example of round cross section. The discharge end 64b of the fourth tubeline 64 can be disposed between the perforated sheet 75 and the bottom wall 72a of tank 71. In particular the fourth tubeline 64 penetrates for this purpose, preferably substantially centrally, the perforated sheet 75.

Lastly, a sixth tubeline 66 is guided out from the interior volume 73 of tank 71 through the tank wall 72 toward the exterior volume outside of tank 71. Through this tubeline 66 the coolant buffered in the interior volume 73 of tank 71 is removed again from tank 71. The sixth tubeline 66 can comprise an intake end 66a, disposed in the interior volume 73 of tank 71, which is disposed in the interior volume 73 in the top region 72b of tank 71.

The fifth tubeline 65 and the sixth tubeline 66 can terminate with a discharge end 65b, 66b, into a second T fitting 69 which is preferably developed as a three-way valve, especially preferred as a three-way switchover valve. The second T fitting 69 can herein be disposed in the exterior volume outside of tank 71.

Whether to the cooling circuit 20 coolant is directly supplied from the heat exchanger 50, especially from the second side 52 of heat exchanger 50, or from the interior volume 73 of tank 71 of buffer storage 70 can consequently be controlled or adjusted across the second T fitting 69.

The cooling circuit 20 depicted in FIG. 3 comprises a cold source 22 with a forerun 22a and a return 22b, a consumer heat exchanger 24 with a forerun 24a and a return 24b, which heat exchanger is disposed in the return 22b of the cold source 22, and a circulation pump 26 in the return 24b of the consumer heat exchanger 24 and in the forerun 22a of the cold source 22. The circulation pump 26 can alternatively also be disposed in the forerun 24a of the consumer heat exchanger 24.

Between the return 22b of the cold source 22 and the forerun 24a of the consumer heat exchanger 24 is disposed a first three-way junction 41, and between the return 24b if the consumer heat exchanger 24 and the forerun 22a of the cold source 22 is disposed a second three-way junction 42 wherein the first three-way junction 41 and the second three-way junction 42 are connected with a bypass line 45. The circulation pump 26 is herein disposed either between the first three-way junction 41 and the forerun 24a of the consumer heat exchanger 24 or, as depicted in FIG. 3, between the return 24b of the consumer heat exchanger 24 and the second three-way junction 42.

The first three-way junction 41 and/or the second three-way junction 42 can be developed as three-way valves 30. In the present case only the first three-way junction 41 is developed as a three-way valve 30, wherein the first inlet 31 of the three-way valve 30 is connected with the return 22b of the cold source 22, an outlet 33 of the three-way valve 30 is in connection with the forerun 24a of the consumer heat exchanger 24 and a second inlet 32 of the three-way valve 30 is in connection across the second three-way junction 42 with the return 26b of the circulation pump 26 and the forerun 22a of the cold source 22.

The cooling circuit 20 comprises the buffer storage 70 according to FIGS. 1 and 2. The buffer storage 70 including the heat exchanger 50 is herein in particular disposed such in the cooling circuit 20 that the cold source 22 of the cooling circuit 20 is formed by the second side 52 of the heat exchanger 50 disposed in the buffer storage 70.

The first side 51 of the heat exchanger 50 disposed in the buffer storage 70 can in particular be part of an external refrigerant circuit 80, which comprises, for example, a refrigeration unit 82 (see FIG. 3). To this end, the buffer storage 70 can be disposed such that the first tubeline 61 is in connection with the return of the refrigeration unit 82 and the second tubeline 62 is in connection with the forerun of the refrigeration unit 82. As coolant of the external refrigerant circuit 80 a combustible coolant, for example a hydrocarbon, in particular propane or isobutane, can be utilized.

Furthermore, the buffer storage 70 can be disposed in the cooling circuit 20 such that the forerun 22a is connected with the second intake 52a of the second side 52 of the heat exchanger 50. In particular, an intake opening 63a of the third tubeline 63 can be connected with an outlet of the second three-way junction 42.

The buffer storage 70 can furthermore be disposed in the cooling circuit 20 such that return 22b is in connection with the discharge 52b of the second side 52 of heat exchanger 50. In particular, the outlet of the second T fitting 69 can be connected with the first inlet 31 of three-way valve 30 of the first three-way junction 41. The discharge opening 65b of the fifth tubeline 65 and the discharge opening 66b of the sixth tubeline 66 can herein terminate into the second T fitting 69.

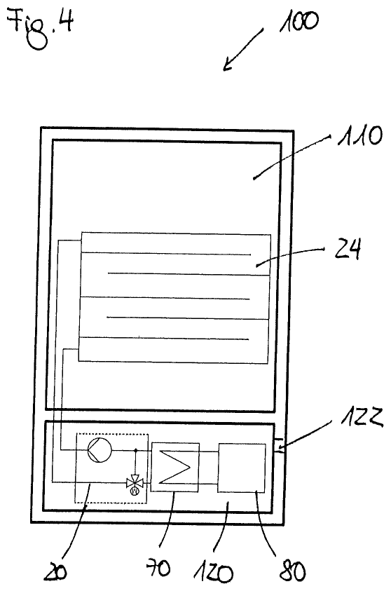

The thermostatic assembly 10 can, for example, be operated in the following manner: the cold source 22, in particular the second side 52 of heat exchanger 50 makes available a cold coolant which, with the aid of the circulation pump 26, is supplied to the consumer heat exchanger 24 through the first inlet 31 of the three-way valve 30 and the outlet 33 of the three-way valve 30. Across the consumer heat exchanger 24 a sample compartment 110 can be cooled, wherein energy is input into the coolant in the consumer heat exchanger 24. The sample compartment 110 is in particular a portion of a laboratory chamber, climate chamber, cold chamber or environment simulation chamber 100 as shown in FIG. 4. The cooling circuit 20, as a rule, is layed out of such size that the temperature of the coolant does not change too significantly through the consumer, in the present case the sample compartment 110 of the laboratory chamber, climate chamber, cold chamber or environment simulation chamber 100. In the return 26b of the circulation pump 26 a temperature sensor can be disposed, with the aid of which the energy difference can be determined. At the first inlet 31 of the three-way valve 30 subsequently such quantity of cold coolant can be supplied that at the outlet 33 of the three-way valve 30 coolant is available at the desired temperature. Depending on the required temperature, either cold coolant can be supplied directly from the second side 52 of heat exchanger 50 or optionally less cold coolant from the interior volume 73 of tank 71 of the buffer storage 70. Only a quantity corresponding to the quantity of supplied cold coolant is supplied to the returning warmer coolant by the consumer heat exchanger 24 by the circulation pump 26 directly to the cold source 22 in order to be cooled here anew. Depending on the demand of cold coolant, the coolant cooled by the second side 52 of the heat exchanger is supplied to the tank 71 of buffer storage 70 across the fourth tubeline 64 and be buffered here or across the fifth tubeline 65 to the cooling circuit 20.

The thermostatic assembly 10 can additionally comprise a heating unit 40 which is disposed between the first three-way junction 41 and the consumer heat exchanger 24, in particular between the three-way valve 30 and the consumer heat exchanger 24. The coolant supplied to the consumer heat exchanger 24 through the outlet 33 of the three-way valve 30 can be heated by the heating unit 40 to the desired temperature in order to enable temperature control within a wider temperature range.

FIG. 4 shows a laboratory chamber, climate chamber, cold chamber or environment simulation chamber 100 with a sample compartment 110 and a thermostatic assembly 10 as described in conjunction with FIG. 3, wherein the consumer heat exchanger 24 is disposed such that it controls or maintains the temperature of sample compartment 110. The laboratory chamber, climate chamber, cold chamber or environment simulation chamber 100 comprises a machine compartment 120, separated from the sample compartment 110, wherein the external refrigerant circuit 80, preferably including the second heat exchanger 50, as depicted in FIG. 4 including the buffer storage 70, in which the second heat exchanger 50 is disposed, is disposed in the machine compartment. The machine compartment 120 comprises in particular ventilation apertures 122 and can thereby meet the safety requirements regarding the use of combustible coolants, in particular hydrocarbons, such as propane or isobutane. Only the consumer heat exchanger 24 of the thermostatic assembly 10 is advantageously disposed in or on the sample compartment 110 while the further components of the thermostatic assembly 10 are disposed spatially separated in the machine compartment 120.

### LIST OF REFERENCE NUMBERS

10 Thermostatic assembly
20 Cooling circuit
22 Cold source
22a Forerun
22b Return
24 Consumer heat exchanger
24a Forerun
24b Return
26 Circulation pump
26a Forerun
26b Return
28 Temperature sensor
30 Three-way valve
31 First inlet
32 Second inlet
33 Outlet
40 Heating unit
41 First three-way junction
42 Second three-way junction
45 Bypass line
50 Heat exchanger
51 First side
51a First intake
51b First discharge
52 Second side
52a Second intake
52b Second discharge
55 Diathermic wall
61 First tubeline
62 Second tubeline
63 Third tubeline
63a Intake opening
64 Fourth tubeline
64b Outlet end
65 Fifth tubeline
65a Intake opening
65b Discharge opening
66 Sixth tubeline
66a Intake opening
66b Discharge opening
68 T fitting
69 T fitting
70 Buffer storage
71 Tank
72 Tank wall
72a Bottom wall
72b Top wall
72c Side wall
73 Interior volume
73a Bottom region
73b Top region
75 Perforated sheet
80 External refrigerant circuit
82 Refrigeration unit
100 Laboratory chamber, climate chamber, cold chamber or environment simulation chamber
110 Sample compartment
120 Machine compartment
122 Ventilation aperture

What is claimed is:

1. A buffer storage for a cooling circuit of a thermostatic assembly, comprising:
a tank having a tank wall encompassing an interior volume,
a heat exchanger, disposed within the interior volume of the tank, the heat exchanger comprising:
a first side with a first intake and a first discharge for a first coolant, and
a second side, separated from the first side by a diathermic wall, with a second intake and a second discharge for a second coolant,
a first tubeline guided from an exterior volume outside of the tank through the tank wall to the first intake,
a second tubeline guided from the first discharge through the tank wall toward the exterior volume outside of the tank,
a third tubeline guided from the exterior volume outside of the tank through the tank wall to the second intake,
a fourth tubeline connected across a T-fitting with the second discharge, wherein the forth tubeline terminates into the interior volume of the tank,
a fifth tubeline guided through the tank wall toward the exterior volume outside of the tank, and
a sixth tubeline guided from the interior volume of the tank through the tank wall toward the exterior volume outside of the tank.

2. The buffer storage as in claim 1, wherein the T fitting is a three-way valve.

3. The buffer storage as in claim 1, wherein the sixth tubeline comprises an intake end, disposed in the interior volume of the tank, which is disposed in the interior volume in a top region of the tank.

4. The buffer storage as claim 1, wherein the fourth tubeline comprises a discharge end disposed in the interior volume of the tank.

5. The buffer storage as in claim 1, wherein in the interior volume of the tank a perforated sheet is disposed in the bottom region of the tank.

6. The buffer storage as claim 1, wherein the discharge end of the fourth tubeline is disposed between the perforated sheet and the bottom wall of the tank.

7. The buffer storage as claim 1, wherein the fifth tubeline and the sixth tubeline terminate with respective discharge ends terminating into a second T fitting.

8. The buffer storage as claim 7, wherein the second T fitting is a three-way valve.

9. The buffer storage as in claim 1, wherein the heat exchanger is a plate heat exchanger or a coaxial tube heat exchanger.

10. A thermostatic assembly with a cooling circuit with a coolant, wherein the cooling circuit comprises a cold source, a consumer heat exchanger in the return of the cold source and a circulation pump, wherein between the return of the cold source and the forerun of the consumer heat exchanger a first three-way junction is disposed and between the return of the consumer heat exchanger and the forerun of the cold source a second three-way junction is disposed, wherein the first three-way junction and the second three-way junction are connected with a bypass line and the circulation pump is disposed either between the first three-way junction and the forerun of the consumer heat exchanger or between the return of the consumer heat exchanger and the second three-way junction, wherein the thermostatic assembly comprises a buffer storage as in claim 1, wherein the second side of the heat exchanger disposed in the buffer storage forms the cold source and the first side of the heat exchanger disposed in the buffer storage is a portion of an external refrigerant circuit.

11. The thermostatic assembly as in claim 10, wherein an intake opening of the third tubeline is connected with an outlet of the second three-way junction and that the discharge opening of the fifth tubeline and the discharge opening of the sixth tubeline terminate into a second T fitting whose outlet is connected with an inlet of the first three-way junction.

12. The thermostatic assembly as in claim 10, wherein the external refrigerant circuit comprises a refrigeration unit, and the buffer storage is disposed such that the first tubeline is in connection with the return of the refrigeration unit and the second tubeline is in connection with the forerun of the refrigeration unit.

13. The thermostatic assembly as in claim 10, wherein the first three-way junction and/or the second three-way junction are developed as three-way valves.

14. The thermostatic assembly as in claim 10, wherein between the first three-way junction and the consumer heat exchanger a heating unit is disposed.

15. A laboratory chamber, climate chamber, cold chamber or environment simulation chamber with a sample compartment and a thermostatic assembly as in claim 9, wherein the consumer heat exchanger is disposed such that it maintains temperature control of the sample compartment.
